(19) United States
(12) Patent Application Publication
(10) Pub. No.: US 2023/0222811 A1
(43) Pub. Date: Jul. 13, 2023

(54) SYNCHRONIZED VEHICLE OPERATION

(71) Applicant: Ford Global Technologies, LLC, Dearborn, MI (US)

(72) Inventors: Pietro Buttolo, Dearborn Heights, MI (US); Stuart C. Salter, White Lake, MI (US); Kristin A. Hellman, Walled Lake, MI (US); David Kennedy, Canton, MI (US); William H. Wurz, San Francisco, CA (US)

(73) Assignee: Ford Global Technologies, LLC, Dearborn, MI (US)

(21) Appl. No.: 17/570,503

(22) Filed: Jan. 7, 2022

(51) Int. Cl. G06V 20/58; B60W 50/14; B60W 50/10; H04W 4/46; G06F 1/12

(52) U.S. Cl. CPC G06V 20/584; B60W 50/14; B60W 50/10; H04W 4/46; G06F 1/12; B60W 2420/42; B60W 2050/146

(57) ABSTRACT

While a host vehicle is within an area, a target vehicle is identified based on detecting the target vehicle within the area. Upon determining a component output, first instructions specifying the component output and a target vehicle component are provided to the target vehicle. A host clock for the host vehicle is synchronized with a clock maintained by a remote server computer. Then second instructions specifying to initiate, at a target time, actuation of the target vehicle component to provide the component output are provided to the target vehicle. Then a host vehicle component is actuated at a host time to provide the component output.

### BACKGROUND

A vehicle can be equipped with electronic and electro-mechanical components, e.g., computing devices, networks, sensors, controllers, etc. Vehicle sensors can provide data about objects in an environment around the vehicle. Additionally, vehicle-to-vehicle (V2V) communications can allow for vehicles to provide each other with such data. A vehicle computing device can operate a vehicle and make real-time decisions based on data received from sensors and/or other vehicles.

### BRIEF DESCRIPTION OF THE DRAWINGS

FIG. 1 is a block diagram illustrating an example control system for a vehicle.

FIGS. 2A-2B are diagrams of an example operating area.

FIG. 3A is a block diagram illustrating an example request message.

FIG. 3B is a block diagram illustrating an example availability message.

FIG. 4 is a flowchart of an example process for providing a host component output in a vehicle computer.

FIG. 5 is a flowchart of an example process for providing a target component output in a second computer.

### DETAILED DESCRIPTION

A vehicle computer can determine to actuate one or more vehicle components to provide a component output (as discussed below) based on, e.g., detecting a user input via a human-machine interface (HMI) specifying the component output, receiving a message from a user device specifying the component output, etc. Further, a plurality of vehicles could output the component output, e.g., to improve an audio and/or visual quality of the output. However, synchronizing component outputs between a plurality of vehicles can be difficult due communication latency between vehicle and/or remote computing devices, discrepancies between clocks maintained by respective vehicles, sensor latency between receiving and detecting a user input, etc.

Advantageously, a vehicle computer can identify target vehicles available for providing a component output within an area and provide first instructions for providing the component output to the target vehicles. The vehicle computer then provides second instructions to the target vehicles specifying a time at which to provide the component output and actuates vehicle one or more components to provide the component output at the specified time. The time is specified according to a clock maintained by a remote server computer, which allows the vehicle computer and computers in the target vehicles to resolve discrepancies between local clocks maintained by the respective computers. Providing instructions to the target vehicles specifying a future time to actuate specified vehicle components allows the vehicle computer to synchronize a component output from a plurality of vehicles, which can improve an audio and/or visual quality of the output.

A system includes a computer including a processor and a memory, the memory storing instructions executable by the processor to, while a host vehicle is within an area, identify a target vehicle based on detecting the target vehicle within the area. The instructions further include instructions to, upon determining a component output, provide, to the target vehicle, first instructions specifying the component output and a target vehicle component. The instructions further include instructions to synchronize a host clock for the host vehicle with a clock maintained by a remote server computer. The instructions further include instructions to then provide, to the target vehicle, second instructions specifying to initiate, at a target time, actuation of the target vehicle component to provide the component output. The instructions further include instructions to then actuate, at a host time, a host vehicle component to provide the component output.

The instructions can further include instructions to determine an availability of the target vehicle to provide the component output based on receiving, from a second computer in the target vehicle, a message specifying the availability.

The system can include a second computer in the target vehicle. The second computer can include a second processor and a second memory storing instructions executable by the second processor such that the second computer is programmed to, upon receiving the first instructions, synchronize a target clock for the target vehicle with the clock maintained by the remote server.

The second computer can be further programmed to actuate, at the target time, the target vehicle component to provide the component output.

The component output can be one of a light output or a sound output.

The first instructions further specify a parameter of the component output, the parameter including at least one of a volume, a duration, or a light intensity.

The instructions can further include instructions to determine poses for the host vehicle and the target vehicle within the area based on the component output.

The instructions can further include instructions to provide the pose for the target vehicle to the target vehicle.

The system can include a second computer in the target vehicle. The second computer can include a second processor and a second memory storing instructions executable by the second processor such that the second computer is programmed to operate the target vehicle to the pose for the target vehicle.

The instructions can further include instructions to operate the host vehicle to the pose for the host vehicle.

The instructions can further include instructions to determine the component output based on receiving a user input.

The component output includes a target component output and a host component output different from the target component output. The instructions can further include instructions to provide the host component output.

The system can include a second computer in the target vehicle. The second computer can include a second processor and a second memory storing instructions executable by the second processor such that the second computer is programmed to provide the target component output.

The host time and the target time can be a same time.

The host time and the target time can be a different time.

A method includes, while a host vehicle is within an area, identifying a target vehicle based on detecting the target vehicle within the area. The method further includes, upon determining a component output, providing, to the target vehicle, first instructions specifying the component output and a target vehicle component. The method further includes synchronizing a host clock for the host vehicle with a clock maintained by a remote server computer. The method further includes then providing, to the target vehicle, second instructions specifying to initiate, at a target time, actuation of the target vehicle component to provide the component output. The method further includes then actuating, at a host time, a host vehicle component to provide the component output.

The component output can be one of a light output or a sound output.

The method can further include determining the component output based on receiving a user input.

The host time and the target time can be a same time.

The host time and the target time can be a different time.

Further disclosed herein is a computing device programmed to execute any of the above method steps. Yet further disclosed herein is a computer program product, including a computer readable medium storing instructions executable by a computer processor, to execute an of the above method steps.

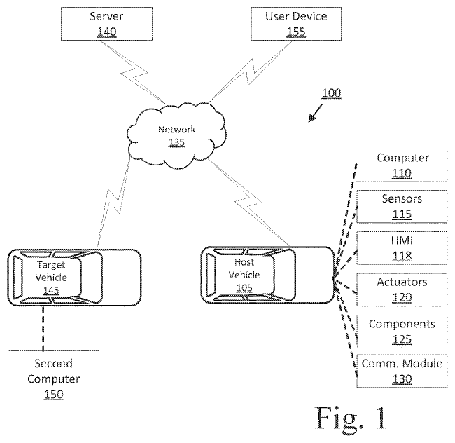

With reference to FIGS. 1-3B, an example vehicle control system 100 includes a host vehicle 105. A vehicle computer 110 in the host vehicle 105 receives data from sensors 115. The vehicle computer 110 is programmed to, while the host vehicle 105 is within an operating area 200, identify a target vehicle 145 based on detecting the target vehicle 145 within the operating area 200. The vehicle computer 110 is further programmed to, upon determining a component output, provide, to the target vehicle 145, first instructions specifying the component output and a target vehicle 145 component. The vehicle computer 110 is further programmed to synchronize a host clock for the host vehicle 105 with a clock maintained by a remote server computer 140. The vehicle computer 110 is further programmed to then provide, to the target vehicle 145, second instructions specifying to initiate, at a target time, actuation of the target vehicle 145 component to provide the component output. The vehicle computer 110 is further programmed to then actuate, at a host time, a host vehicle component 125 to provide the component output.

Turning now to FIG. 1, the host vehicle 105 includes the vehicle computer 110, sensors 115, actuators 120 to actuate various vehicle components 125, and a vehicle communications module 130. The communications module 130 allows the vehicle computer 110 to communicate with a remote server computer 140, a user device 155, and/or other vehicles, e.g., via a messaging or broadcast protocol such as Dedicated Short Range Communications (DSRC), cellular, IEEE 802.11, Bluetooth®, Ultra-Wideband (UWB), and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation, e.g., an ASIC for processing sensor data and/or communicating the sensor data. In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the vehicle computer 110.

The vehicle computer 110 may operate and/or monitor the host vehicle 105 in an autonomous mode, a semi-autonomous mode, or a non-autonomous (or manual) mode, i.e., can control and/or monitor operation of the host vehicle 105, including controlling and/or monitoring components 125. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicle 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the host vehicle 105 by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communications network such as a communications bus as described further below, more than one processor, e.g., included in electronic controller units (ECUs) or the like included in the host vehicle 105 for monitoring and/or controlling various vehicle components 125, e.g., a transmission controller, a brake controller, a steering controller, etc. The vehicle computer 110 is generally arranged for communications on a vehicle communication network that can include a bus in the host vehicle 105 such as a controller area network (CAN) or the like, and/or other wired and/or wireless mechanisms.

Via the host vehicle 105 network, the vehicle computer 110 may transmit messages to various devices in the host vehicle 105 and/or receive messages (e.g., CAN messages) from the various devices, e.g., sensors 115, an actuator 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the host vehicle 105, behind a vehicle 105 front windshield, around the host vehicle 105, etc., that provide relative locations, sizes, and shapes of objects surrounding the host vehicle 105. As another example, one or more radar sensors 115 fixed to vehicle 105 bumpers may provide data to provide locations of the objects, target vehicles 145, etc., relative to the location of the host vehicle 105. The sensors 115 may further alternatively or additionally, for example, include camera sensor(s) 115, e.g. front view, side view, etc., providing images from an area surrounding the host vehicle 105. In the context of this disclosure, an object is a physical, i.e., material, item that has mass and that can be represented by physical phenomena (e.g., light or other electromagnetic waves, or sound, etc.) detectable by sensors 115. Thus, the host vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the host vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle, a sign, a tree, etc., relative to the host vehicle 105. As one example, the data may be image data of the environment around the host vehicle 105. In such an example, the image data may include one or more objects and/or markings, e.g., lane markings, on or along a road. Image data herein means digital image data, e.g., comprising pixels with intensity and color values, that can be acquired by camera sensors 115. The sensors 115 can be mounted to any suitable location in or on the host vehicle 105, e.g., on a vehicle 105 bumper, on a vehicle 105 roof, etc., to collect images of the environment around the host vehicle 105.

The host vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of the host vehicle 105.

In the context of the present disclosure, a vehicle component 125 is one or more hardware components adapted to perform a mechanical or electro-mechanical function or operation—such as moving the host vehicle 105, slowing or stopping the host vehicle 105, steering the host vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

The host vehicle 105 further includes a human-machine interface (HMI) 118. The HMI 118 includes user input devices such as knobs, buttons, switches, pedals, levers, touchscreens, and/or microphones, etc. The input devices may include sensors 115 to detect a user input and provide user input data to the vehicle computer 110. That is, the vehicle computer 110 may be programmed to receive user input from the HMI 118. The user may provide the user input via the HMI 118, e.g., by selecting a virtual button on a touchscreen display, by providing voice commands, etc. For example, a touchscreen display included in an HMI 118 may include sensors 115 to detect that a user selected a virtual button on the touchscreen display to, e.g., select or deselect an operation, which input can be received in the vehicle computer 110 and used to determine the selection of the user input.

The HMI 118 typically further includes output devices such as displays (including touchscreen displays), speakers, and/or lights, etc., that output signals or data to the user. The HMI 118 is coupled to the vehicle communication network and can send and/or receive messages to/from the vehicle computer 110 and other vehicle sub-systems.

In addition, the vehicle computer 110 may be configured for communicating via a vehicle-to-vehicle communication module 130 or interface with devices outside of the host vehicle 105, e.g., through a vehicle-to-vehicle (V2V) or vehicle-to-infrastructure (V2X) wireless communications (cellular and/or DSRC., etc.) to another vehicle, and/or to a remote server computer 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth®, UWB, IEEE 802.11, dedicated short range communications (DSRC), and/or wide area networks (WAN), including the Internet, providing data communication services.

The network 135 represents one or more mechanisms by which a vehicle computer 110 may communicate with remote computing devices, e.g., the remote server computer 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, UWB, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device, i.e., including one or more processors and one or more memories, programmed to provide operations such as disclosed herein. Further, the remote server computer 140 can be accessed via the network 135, e.g., the Internet, a cellular network, and/or or some other wide area network.

A target vehicle 145 is a vehicle detected by the host vehicle 105. The target vehicle 145 includes a second computer 150. The second computer 150 includes a second processor and a second memory such as are known. The second memory includes one or more forms of computer-readable media, and stores instructions executable by the second computer 150 for performing various operations, including as disclosed herein.

Additionally, the target vehicle 145 may include sensors, actuators to actuate various vehicle components, an HMI, and a vehicle communications module. The sensors, actuators to actuate various vehicle components, the HMI, and the vehicle communications module typically have features in common with the sensors 115, actuators 120 to actuate various host vehicle components 125, the HMI 118, and the vehicle communications module 130, and therefore will not be described further to avoid redundancy.

The user device 155 can be a conventional computing device, i.e., including one or more processors and one or more memories, programmed to provide operations such as disclosed herein. The user device 155 can be any one of a variety of computers that can be used while carried by a person, e.g., a smartphone, a tablet, a personal digital assistant, a smart watch, a key fob, etc. Further, the user device 155 can be accessed via the network 135, e.g., the Internet, a cellular network, and/or or some other wide area network.

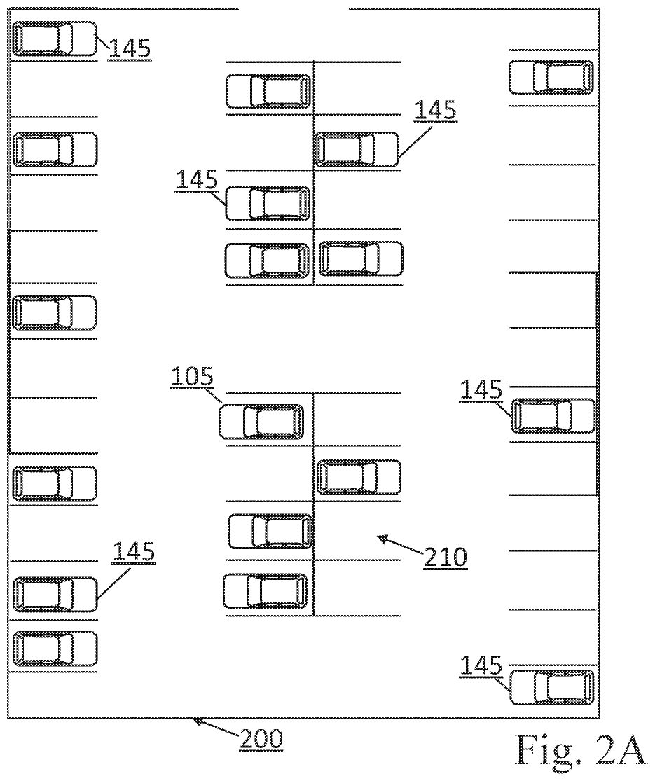

FIGS. 2A and 2B are diagrams illustrating a vehicle 105 operating in an example operating area 200 that includes marked sub-areas 210 (e.g., parking spaces) for vehicles 105. The vehicle computer 110 may be programmed to determine whether the host vehicle 105 is in an operating area 200. An operating area 200 is a specified area of ground surface for operating and/or stowing a vehicle 105. The operating area 200 may be on a street or road, e.g., an area alongside a curb or an edge of the street, a parking lot or structure or portion thereof, etc. A sub-area 210 may, for example, be a parking space indicated by conventional markings, e.g., painted lines on a ground surface, and conventional image recognition techniques can be employed by the vehicle computer 110 to identify the sub-area 210.

The vehicle computer 110 may be programmed to determine that the host vehicle 105 is within the operating area 200 based on sensor 115 data. For example, the vehicle computer 110 may be programmed to determine that the host vehicle 105 is within the operating area 200 by any suitable technique for determining a location of the host vehicle 105, e.g., GPS-based geo-fencing. A geo-fence herein has the conventional meaning of a boundary for an area defined by sets of geo-coordinates. In such an example, the geo-fence specifies a perimeter of the operating area 200. The vehicle computer 110 can then determine that the host vehicle 105 is within the operating area 200 based on the location data of the host vehicle 105 indicating the host vehicle 105 is within the geo-fence. As another example, the vehicle computer 110 may determine whether the host vehicle 105 is in the operating area 200 based on data, e.g., map data, received from the remote server computer 140. For example, the vehicle computer 110 may receive a location of the host vehicle 105, e.g., from a sensor 115, a navigation system, a remote server computer 140, etc. The vehicle computer 110 can compare the location of the host vehicle 105 to the map data, e.g., to determine whether the host vehicle 105 is in the operating area 200 specified in the map data.

The vehicle computer 110 can, for example, determine a pose of the host vehicle 105 based on the location data of the host vehicle 105. For example, the location data may specify geo-coordinates such as latitude and longitude coordinates and an orientation of the host vehicle 105 relative to a real-world, i.e., GPS, coordinate system. The pose of the host vehicle 105 may be specified in six degrees-of-freedom. Six degrees-of-freedom conventionally and in this document refers to freedom of movement of an object in three-dimensional space, e.g., translation along three perpendicular axes and rotation about each of the three perpendicular axes. A six degree-of-freedom pose of the host vehicle 105 means a location relative to a coordinate system (e.g., a set of coordinates specifying a positing in the coordinate system, e.g., X, Y, and Z coordinates) and an orientation (e.g., a yaw, a pitch, and a roll) about each axis in the coordinate system. The pose of the host vehicle 105 can be determined in real world coordinates based on orthogonal x, y, and z axes and roll, pitch, and yaw rotations about the x, y, and z axes, respectively. The pose of the host vehicle 105 locates the host vehicle 105 with respect to the real world coordinates.

While in the operating area 200, the vehicle computer 110 can be programmed to determine an availability of the host vehicle 105. The host vehicle 105 is one of available or unavailable. An “available” vehicle is permitted to provide a component output (as discussed below). An “unavailable” vehicle is not permitted to provide a component output.

The vehicle computer 110 can determine an availability of the host vehicle 105 based on a first user input. For example, the vehicle computer 110 can actuate and/or instruct the HMI 118 to display a virtual button that the user can select to specify that the host vehicle 105 is available. In other words, the HMI 118 may activate sensors 115 that can detect the user selecting a virtual button to specify that the host vehicle 105 is available. Upon detecting the first user input, the HMI 118 can provide the first user input to the vehicle computer 110, and the vehicle computer 110 can determine the host vehicle 105 is available. As another example, the user device 155 can display the virtual button that the user can select to specify that the host vehicle 105 is available. In other words, the user device 155 may detect the first user input, e.g., in substantially the same manner as the HMI 118. Upon detecting the first user input, the user device 155 can provide the first user input, e.g., by transmitting the first user input via the network 135, to the vehicle computer 110, and the vehicle computer 110 can determine the host vehicle 105 is available.

The vehicle computer 110 can determine that the host vehicle 105 is unavailable based on detecting an absence of the first user input. Alternatively, the vehicle computer 110 can determine that the host vehicle 105 is unavailable based on the first user input specifying that the host vehicle 105 is unavailable. In this situation, the HMI 118 (or the user device 155) can further display a virtual button that the user can select to specify that the host vehicle 105 is unavailable. Upon determining that the user selected the virtual button specifying that the host vehicle 105 is unavailable, e.g., in substantially the same manner as just discussed, the vehicle computer 110 can determine that the host vehicle 105 is unavailable. Upon determining that the host vehicle 105 is unavailable, the vehicle computer 110 can prevent the HMI 118 from detecting a second user input specifying a component output (as discussed below). Additionally, or alternatively, the host vehicle 105 can ignore a message received from the user device 155 specifying the second user input.

Upon determining that the host vehicle 105 is available, the vehicle computer 110 is programmed to detect a target vehicle 145 in the operating area 200. For example, the vehicle computer 110 can receive location data of the target vehicle 145 from the second computer 150, e.g., via V2V communications. The vehicle computer 110 can determine that the target vehicle 145 is within the operating area 200 based on comparing the location data of the target vehicle 145 to the geo-fence or the map data, e.g., in substantially the same manner as discussed above regarding determining whether the host vehicle 105 is within the operating area 200. Additionally, or alternatively, while in the operating area 200, the vehicle computer 110 can receive sensor 115 data, e.g., image data, of the environment around the host vehicle 105 in the operating area 200. The sensor 115 data can include the target vehicle 145 in the operating area 200 around the host vehicle 105. The vehicle computer 110 can detect the target vehicle 145 based on the sensor 115 data. For example, object classification or identification techniques, can be used, e.g., in the vehicle computer 110 based on lidar sensor 115, camera sensor 115, etc., data to identify a type of object, e.g., a vehicle, a bicycle, an aerial drone, etc., as well as physical features of objects.

Various techniques such as are known may be used to interpret sensor 115 data and/or to classify objects based on sensor 115 data. For example, camera and/or lidar image data can be provided to a classifier that comprises programming to utilize one or more conventional image classification techniques. For example, the classifier can use a machine learning technique in which data known to represent various objects is provided to a machine learning program for training the classifier. Once trained, the classifier can accept as input vehicle sensor 115 data, e.g., an image, and then provide as output, for each of one or more respective regions of interest in the image, an identification and/or a classification (i.e., movable or non-movable) of one or more objects or an indication that no object is present in the respective region of interest. Further, a coordinate system (e.g., polar or cartesian) applied to an area proximate to the host vehicle 105 can be used to specify locations and/ or areas (e.g., according to the host vehicle 105 coordinate system, translated to global latitude and longitude geo-coordinates, etc.) of objects identified from sensor 115 data. Yet further, the vehicle computer 110 could employ various techniques for fusing (i.e., incorporating into a common coordinate system or frame of reference) data from different sensors 115 and/or types of sensors 115, e.g., lidar, radar, and/or optical camera data.

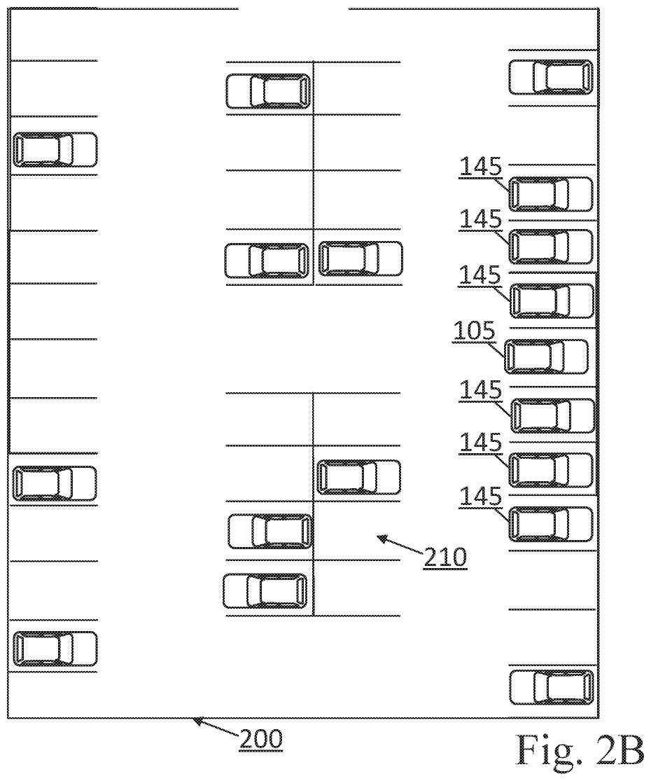

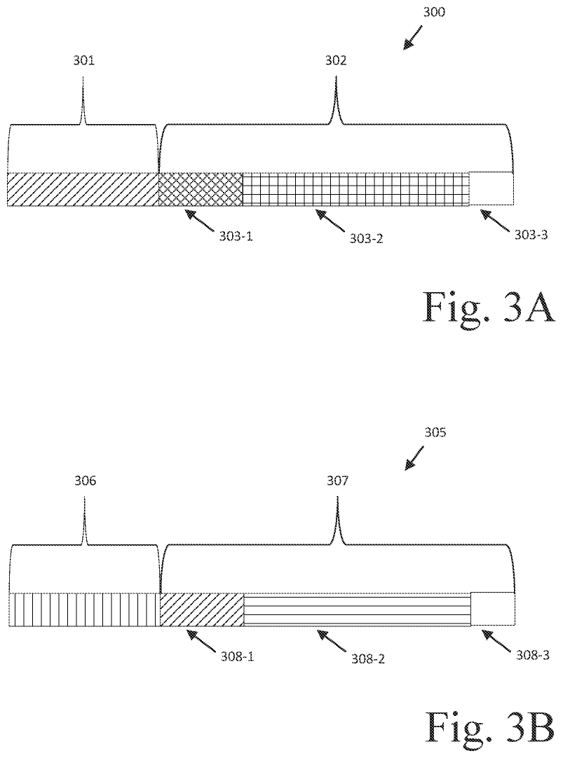

Upon identifying the type of object as a vehicle and/or determining the vehicle is in the operating area 200, the vehicle computer 110 is programmed to identify the vehicle as a target vehicle 145. The vehicle computer 110 is programmed to then determine an availability of the target vehicle 145. The target vehicle 145 is one of available or unavailable. Upon identifying the target vehicle 145, the vehicle computer 110 can, for example, generate a request message 300. A request message includes a header 301 and a payload 302 (see FIG. 3A). The header 301 of the request message 300 may include a message type, a message size, etc. The payload 302 may include various data, i.e., message content. The payload 302 can include sub-payloads or payload segments 303-1, 303-2, 303-3 (collectively, referred to as payload segments 303). The respective payload segments 303 in FIG. 3A are illustrated as being of different lengths to reflect that different payload segments 303 may include various amounts of data, and therefore may be of different sizes, i.e., lengths. The payload 302 of the request message 300 includes, e.g., in a specified payload segment 303, a request to specify an availability of the target vehicle 145 to provide a component output.

Upon generating the request message 300, the vehicle computer 110 can provide the request message 300 to the second computer 150. For example, the vehicle computer 110 can transmit the request message 300 to the second computer 150, e.g., via V2V communications. The second computer 150 can provide an availability message 305 in response to the request message 300, as discussed below.

The vehicle computer 110 can determine the availability of the target vehicle 145 based on the availability message 305. For example, upon receiving the availability message 305, the vehicle computer 110 can access a payload 307, e.g., a specified payload segment 308, of the authentication message 305 and retrieve data specifying the availability of the target vehicle 145. The vehicle computer 110 can store, e.g., in a memory of the vehicle computer 110, a list, a table, a database, etc. including the available target vehicle 145. The vehicle computer 110 can periodically, e.g., at specified time intervals, update the list by identifying one or more available target vehicles 145 in the operating area 200, as just discussed, to increase an accuracy of the list and conserve computational resources, e.g., by removing target vehicles 145 from the list that have departed the operating area 200 and/or are no longer available.

Upon determining that the target vehicle 145 is unavailable, the vehicle computer 110 can ignore the target vehicle 145. Upon determining that the target vehicle 145 is available, the vehicle computer 110 can determine a pose of the target vehicle 145. As one example, the second computer 150 can provide the pose of the target vehicle 145 to the vehicle computer 110, e.g., via V2V communications. As another example, the vehicle computer 110 can determine the pose of the target vehicle 145 based on sensor 115 data. For example, the vehicle computer 110 can obtain sensor 115 data including the target vehicle 145 and analyze the sensor 115 data, e.g., according to known image processing techniques, to determine an intermediate pose of the target vehicle 145 relative to the host vehicle 105. The vehicle computer 110 can then combine the pose of the host vehicle 105 and the intermediate pose of the target vehicle 145, e.g., using known data processing techniques, to determine the pose of the target vehicle 145. That is, the vehicle computer 110 can determine the intermediate pose of the target vehicle 145 in local coordinates, i.e., a Cartesian coordinate system having an origin on the host vehicle 105, and can then transform the local coordinates into real-world coordinates to determine the pose of the target vehicle 145.

When the host vehicle 105 is available, the vehicle computer 110 can determine a component output based on a second user input. For example, the vehicle computer 110 can actuate and/or instruct the HMI 118 to display virtual buttons corresponding to representations of respective component outputs that the user can select to specify the component output, e.g., in substantially the same manner as just discussed. Upon detecting the second user input, the HMI 118 can provide the second user input to the vehicle computer 110, and the vehicle computer 110 can determine the component output specified by the second user input. As another example, the user device 155 can detect the second user input, e.g., in substantially the same manner as discussed above regarding detecting the first user input. In this example, upon detecting the second user input, the user device 155 can provide the second user input to the vehicle computer 110, e.g., in substantially the same manner as discussed above regarding providing the first user input, and the vehicle computer 110 can determine the component output specified by the second user input.

As used herein, a “component output” is a physical phenomena generated to present data. The component output may be a sound output, e.g., an audio signal output via a speaker, and/or a light output, e.g., a visual signal output via exterior lights, interior lights, a display screen, etc. The component output may include a host component output and a target component output. A “host component output” is a component output corresponding to the host vehicle 105. A “target component output” is a component output corresponding to the target vehicle 105. That is, the host vehicle 105 is actuated to provide the host component output, and the target vehicle 145 is actuated to provide the target component output. The target component output may be a same or different component output as the host component output. The vehicle computer 110 and/or the user device 155 can store, e.g., in a respective memory, data indicating the component output, e.g., in an audio file, a visual file, an audiovisual file, etc.

The vehicle computer 110 is programmed to generate first instructions based on the component output. The first instructions specify actuation of one or more vehicle components to provide the component output. For example, when the host component output is different from the target component output, the first instructions specify actuation of the vehicle component(s) 125 to provide the host component output and actuation of the target vehicle 145 component(s) to provide the target component output. When the host component output is the same as the target component output, the first instructions specify actuation of the vehicle component(s) 125 and the target vehicle 145 component(s) to provide the component output.

Additionally, the first instructions can specify one or more parameters for the component output. That is, the first instructions can specify actuation of the vehicle component(s) to satisfy parameters for the component output. As user herein, a “parameter” is a value specifying a measurement of a physical characteristic of the component output. A variety of parameters may be specified for the component output. Parameters for the host component output may be the same as or different from parameters for the target component output, e.g., based on whether the host component output is the same as or different from the target component output. As one example, when the host component output is different from the target component output, at least some of the parameters for the host component output are different from the corresponding parameters for the target component output. As another example, when the host component output is the same as the target component output, at least some of the parameters for the host component output are the same as the corresponding parameters for the target component output. A non-limiting list of example parameters could include a volume, a duration, a light intensity, a color, a frequency, a projection angle, etc.

The vehicle computer 110 can determine the parameters based on the component output. For example, the data indicating the component output may further include data specifying one or more parameters for the component output. Additionally, or alternatively, the vehicle computer 110 can determine one or more parameters based on a third user input. For example, the vehicle computer 110 can receive a third user input, e.g., via the HMI 118 or from the user device 155 (as discussed above), specifying the parameter(s) for the component output.

The vehicle computer 110 may be programmed to generate the first instructions additionally based on the poses of the host vehicle 105 and the target vehicle 145. For example, the first instructions may specify actuation of vehicle component(s) to satisfy different parameters according to the vehicle's 105, 145 pose. For example, the first instructions may specify parameters for the host component output and parameters for the target component output according to respective sub-areas 210 in which the vehicles 105, 145 are located. In such an example, at least some of the parameters for the host component output can differ from corresponding parameters for the target component output. The parameters for the host component output can differ from the parameters for the target component output, for example, to reduce or prevent negative interference between outputs from vehicles 105, 145 in the respective sub-areas 210.

Upon generating the first instructions, the vehicle computer 110 can provide the first instructions to a second computer 150 in an available target vehicle 145. For example, the vehicle computer 110 can transmit, e.g., via V2V communications, the first instructions to the second computer 150.

Additionally, or alternatively, the vehicle computer 110 may be programmed to determine an updated pose for the host vehicle 105 and/or the target vehicle 145 for providing the component output. For example, the vehicle computer 110 can determine updated poses for the vehicles 105, 145 such that the vehicles 105, 145 are located in sub-areas 210 dispersed throughout the operating area 200, e.g., to maximize locations within the operating area 200 at which the component output can be detected, (see FIG. 2A). As another example, the vehicle computer 110 can determine updated poses for the vehicles 105, 145 such that the vehicles 105, 145 are located in successive sub-areas 210, e.g., to improve a quality of the output detected at one location within the operating area 200, (see FIG. 2B).

The vehicle computer 110 can, for example, determine the updated pose(s) by applying known optimization techniques to optimize the output of the component output, e.g., by reducing or preventing negative interference between the host component output and the target component output, by maximizing a portion of the operating area 200 within which the component output is detectable, etc., based on the parameters of the component output and relative positions between the target vehicle 145 component(s) and the vehicle component(s) 125 at the respective vehicle 105, 145 poses. As another example, the vehicle computer 110 can receive a fourth user input, e.g., via the HMI 118 or from the user device 155 (as discussed above), specifying the updated pose(s) for the host vehicle 105 and/or the target vehicle 145 for providing of the component output.

Upon determining an updated pose for the target vehicle 145, the vehicle computer 110 can provide the updated pose for the target vehicle 145 to the second computer 150. For example, the vehicle computer 110 can transmit the updated pose for the target vehicle 145 to the second computer 150, e.g., via V2V communications. The vehicle computer 110 can provide the updated pose for the target vehicle 145 in a same or different transmission as the first instructions.

Upon determining an updated pose for the host vehicle 105, the vehicle computer 110 can operate the host vehicle 105 to the updated pose. For example, the vehicle computer 110 can actuate one or more vehicle components 125 to move the host vehicle 105 from a current pose to the updated pose.

Upon determining the first instructions, the vehicle computer 110 is programmed to synchronize a host clock maintained by the vehicle computer 110 with a clock maintained by the remote server computer 140, e.g., a GPS time clock. The vehicle computer 110 can synchronize the host clock with the clock according to known clock synchronization protocols, e.g., Network Time Protocol (NTP), Precision Time Protocol (PTP), etc.

The vehicle computer 110 is programmed to determine second instructions for the component output. The second instructions specify a time at which to initiate actuation of the vehicle component(s) to provide the component output. That is, the second instructions synchronize actuation of the vehicle component(s) to provide the component output. Specifically, the second instructions specify a target time at which to initiate actuation of the target vehicle 145 component(s) to provide the target component output, and a host time at which to initiate actuation of the vehicle component(s) 125 to provide the host component output. The target time and the host time are respective future times that are at least a predetermined amount of time from a current time. The predetermined amount of time may be determined empirically, e.g., based on testing that allows for determining communication latency between a first vehicle and a second vehicle having a pose relative to the first vehicle, e.g., via V2V communications. The predetermined amount of time may be stored, e.g., in a memory of the vehicle computer 110. The host time may, for example, be a same future time as the target time. Alternatively, the host time may be a different future time than the target time.

The vehicle computer 110 can determine the host time and the target time based on the component output. For example, when the host component output is the same as the target component output, the vehicle computer 110 can determine to provide the host component output and the target component output simultaneously. In this situation, the vehicle computer 110 can determine that the target time is the same as the host time. As another example, when the host component output is different from the target component output, the vehicle computer 110 can determine to provide one of the host component output or the target component output prior to the other of the host component output or the target component output, e.g., to satisfy the parameters of the host and target component outputs. That is, the host time can be different than, e.g., prior or subsequent to, the target time. As yet another example, the vehicle computer 110 can receive a fifth user input, e.g., via the HMI 118 or from the user device 155 (as discussed above), specifying the host time and the target time.

Upon determining the second instructions, the vehicle computer 110 provides the second instructions to the second computer 150 in the available target vehicle 145. For example, the vehicle computer 110 can transmit, e.g., via V2V communications, the second instructions to the second computer 150.

Additionally, the vehicle computer 110 is programmed to compare a current time to the host time. If the current time is before the host time, then the vehicle computer 110 prevents actuation of the vehicle component(s) 125 according to the first instructions. Upon determining that the current time is the host time, the vehicle computer 110 actuates the vehicle component(s) 125, e.g., speakers, exterior lights, etc., according to the first instructions to provide the host component output.

The second computer 150 can receive the request message 300 from the vehicle computer 110. Upon receiving the request message 300, the second computer 150 can determine an availability of the target vehicle 145 based on a sixth user input, e.g., in substantially the same manner as discussed above regarding the vehicle computer 110 determining the availability of the host vehicle 105. Upon determining the availability of the target vehicle 145, the second computer 150 can generate the availability message 305. Similar to the request message 300, the authentication message 305 includes a header 306 and a payload 307, including payload segments 308 (see FIG. 3B). The header 306 of the authentication message 305 may include a message type, a message size, etc. The payload 307, e.g., in a specified payload segment 308, includes the availability of the target vehicle 145. The second computer 150 can then provide the availability message 305 to the vehicle computer 110, e.g., as discussed above regarding providing the request message 300.

When the target vehicle 145 is unavailable, the second computer 150 can ignore the vehicle computer 110. When the target vehicle 145 is available, the second computer 150 can receive the first instructions from the vehicle computer 110, e.g., via V2V communications. Upon receiving the first instructions, the second computer 150 can synchronize a target clock maintained by the second computer 150 with the clock maintained by the remote server computer 140, e.g., in substantially the same manner as discussed above regarding synchronizing the host clock with the clock.

The second computer 150 can receive the updated pose for the target vehicle 145 from the vehicle computer 110, e.g., via V2V communications. Upon receiving the updated pose for the target vehicle 145, the second computer 150 can operate the target vehicle 145 to the updated pose for the target vehicle 145. For example, the second computer 150 can actuate one or more target vehicle 145 components to move the target vehicle 145 to the updated pose.

The second computer 150 can receive the second instructions from the vehicle computer 110, e.g., via V2V communications. Upon receiving the second instructions, the second computer 150 can compare a current time to the target time specified by the second instructions. If the current time is before the target time, then the second computer 150 prevents actuation of the target vehicle 145 component(s) according to the first instructions. Upon determining that the current time is the target time, the second computer 150 actuates the target vehicle 145 component(s), e.g., speakers, exterior lights, etc., according to the first instructions to provide the target component output.

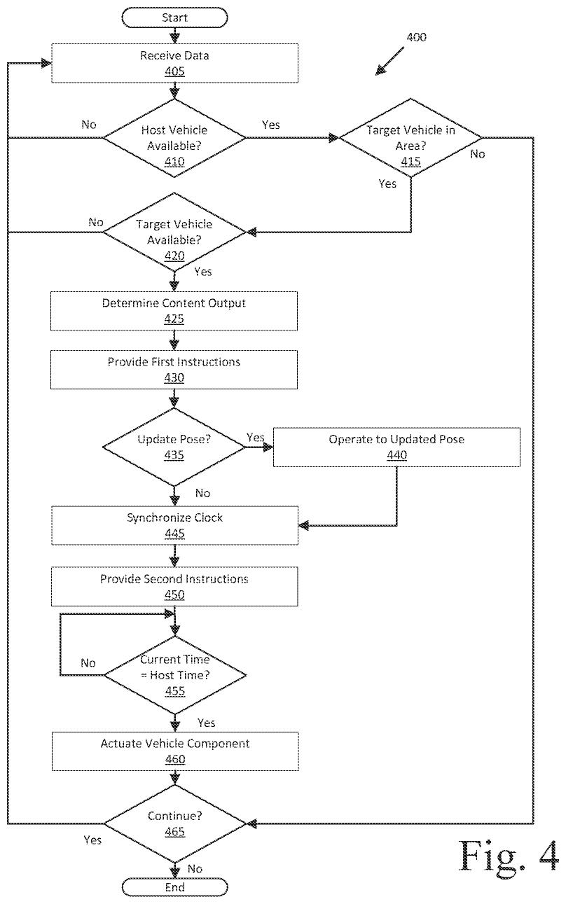

FIG. 4 is a flowchart of an example process 400 executed in a vehicle computer 110 according to program instructions stored in a memory thereof for providing a host component output. Process 400 includes multiple blocks that can be executed in the illustrated order. Process 400 could alternatively or additionally include fewer blocks or can include the blocks executed in different orders.

The process 400 begins in a block 405. In the block 405, the vehicle computer 110 receives data from one or more sensors 115, e.g., via a vehicle network, from a remote server computer 140, e.g., via a network 135, and/or from a second computer 150 in a target vehicle 145, e.g., via V2V communications. For example, the vehicle computer 110 can receive image data, e.g., from one or more image sensors 115, about the operating area 200, e.g., including a pose of a target vehicle 215 in the operating area 200, as discussed above. Additionally, or alternatively, the vehicle computer 110 can receive location data for the host vehicle 105 and/or the target vehicle 145, as discussed above. The process 400 continues in a block 410.

In the block 410, the vehicle computer 110 determines whether the host vehicle 105 is available. The vehicle computer 110 can determine the host vehicle 105 is available based on detecting a first user input, e.g., via the HMI 118, as discussed above. If the vehicle computer 110 determines that the host vehicle 105 is available, then the process 400 continues in a block 415. Otherwise, the process 400 returns to the block 405.

In the block 415, the vehicle computer 110 determines whether the target vehicle 145 is within the operating area 200. The vehicle computer 110 can determine that the target vehicle 145 is within the operating area 200 by comparing location data, e.g., received in the block 405, for the target vehicle 145 to a geo-fence for the operating area 200, as discussed above. If the vehicle computer 110 determines that a target vehicle 145 is within the operating area 200, then the process 400 continues in a block 420. Otherwise, the process 400 continues in a block 465.

In the block 420, the vehicle computer 110 determines whether the target vehicle 145 is available. The vehicle computer 110 can provide a request message 300 to the second computer 150 upon identifying the target vehicle 145 based on the data received in the block 405, as discussed above. The vehicle computer 110 can receive an availability message 305 in response to the request message 300 specifying the target vehicle 145 is available or unavailable, as discussed above. If the vehicle computer 110 determines that the target vehicle 145 is available, then the process 400 continues in a block 425. Otherwise, the process 400 returns to the block 405.

In the block 425, the vehicle computer 110 determines a component output based on a second user input specifying the component output, e.g., via the HMI 118, as discussed above. As explained above, the component output can include a target component output and a host component output. The process 400 continues in a block 430.

In the block 430, the vehicle computer 110 determines first instructions specifying the component output and one or more vehicle components to provide the component output, as discussed above. Upon determining the first instructions, the vehicle computer 110 provides the first instructions to the second computer 150, as discussed above. The process 400 continues in a block 435.

In the block 435, the vehicle computer 110 determines whether to update a pose of the host vehicle 105. As discussed above, the vehicle computer 110 can determine to update the pose of the host vehicle 105 based on optimizing the component output and/or in response to a user input specifying the updated pose. If the vehicle computer 110 determines to update the pose of the host vehicle 105, then the process 400 continues in a block 440. Otherwise, the process 400 continues in a block 445.

In the block 440, the vehicle computer 110 operates the host vehicle 105 to the updated pose. The vehicle computer 110 can actuate one or more vehicle component(s) 125 to move the host vehicle 105 to the updated pose, as discussed above. The process 400 continues in the block 445.

In the block 445, the vehicle computer 110 synchronizes a host clock maintained by the vehicle computer 110 with a clock maintained by a remote server computer 140, as discussed above. The process 400 continues in a block 450.

In the block 450, the vehicle computer 110 determines second instructions for the component output, as discussed above. The second instructions specify a target time and a host time, as discussed above. Upon determining the second instructions, the vehicle computer 110 provides the second instructions to the second computer 150, as discussed above. The process 400 continues in a block 455.

In the block 455, the vehicle computer 110 determines whether a current time is the host time. The vehicle computer 110 compares the current time to the host time, as discussed above. If the current time is earlier than the host time, then the process 400 remains in the block 450. If the current time is the host time, then the process 400 continues in a block 460.

In the block 460, the vehicle computer 110 actuates the vehicle component(s) 125 to provide the host component output, e.g., according to the first instructions. The process 400 continues in the block 465.

In the block 465, the vehicle computer 110 determines whether to continue the process 400. For example, the vehicle computer 110 can determine to continue upon determining that the host vehicle 105 is powered on. In another example, the vehicle computer 110 can determine not to continue when the host vehicle 105 is powered off. If the vehicle computer 110 determines to continue, the process 400 returns to the block 405. Otherwise, the process 400 ends.

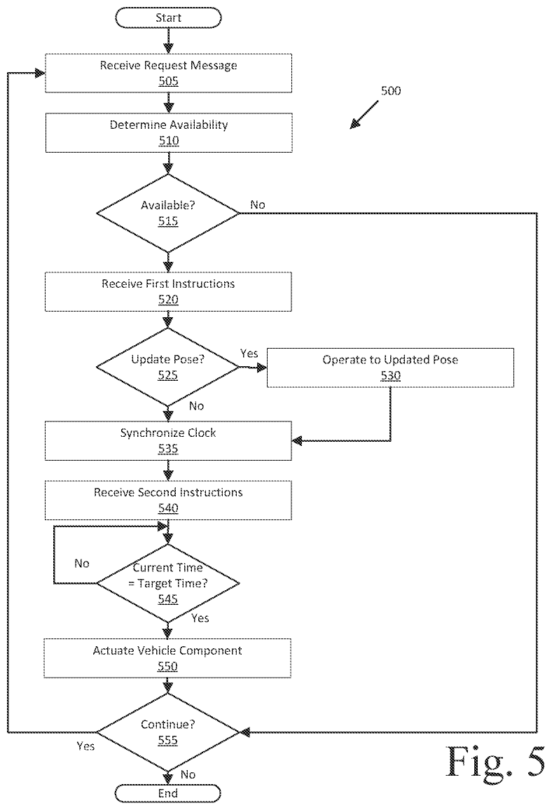

FIG. 5 is a flowchart of an example process 500 executed in a second computer 150 in the target vehicle 145 according to program instructions stored in a memory thereof for providing a target component output. Process 500 includes multiple blocks that can be executed in the illustrated order. Process 500 could alternatively or additionally include fewer blocks or can include the blocks executed in different orders.

The process 500 begins in a block 505. In the block 505, the second computer 150 receives the request message 300 from the vehicle computer 110, e.g., via V2V communications, as discussed above. The process 500 continues in a block 510.

In the block 510, the second computer 150 determines an availability of the target vehicle 145 based on a sixth user input, as discussed above. The process 500 continues in a block 515.

In the block 515, the second computer 150 determines whether the target vehicle 145 is available. If the target vehicle 145 is available, then the process 500 continues in a block 520. Otherwise, the process 500 continues in a block 555.

In the block 520, the second computer 150 receives the first instructions from the vehicle computer 110, e.g., via V2V communications, as discussed above. The process 500 continues in a block 525.

In the block 525, the second computer 150 determines whether to update a pose of the target vehicle 145. The second computer 150 can receive an updated pose for the target vehicle 145 from the vehicle computer 110, as discussed above. If the second computer 150 determines to update the pose of the target vehicle 145, then the process 500 continues in a block 535. Otherwise, the process 500 continues in a block 530.

In the block 530, the second computer 150 operates the target vehicle 145 to the updated pose. The second computer 150 can actuate one or more target vehicle 145 component(s) to move the target vehicle 145 to the updated pose, as discussed above. The process 500 continues in the block 535.

In the block 535, the second computer 150 synchronizes a target clock maintained by the second computer 150 with the clock maintained by the remote server computer 140, as discussed above. The process 500 continues in a block 540.

In the block 540, the second computer 150 receives the second instructions from the vehicle computer 110, e.g., via V2V communications, as discussed above. The process 500 continues in a block 545.

In the block 545, the second computer 150 determines whether a current time is the target time. The second computer 150 compares the current time to the target time, as discussed above. If the current time is earlier than the target time, then the process 500 remains in the block 545. If the current time is the target time, then the process 500 continues in a block 550.

In the block 550, the second computer 150 actuates the target vehicle 145 component(s) to provide the target component output, e.g., according to the first instructions. The process 500 continues in a block 555.

In the block 555, the second computer 150 determines whether to continue the process 500. The block 555 is substantially the same the block 460 of process 400 and therefore will not be described further to avoid redundancy. If the second computer 150 determines to continue, the process 500 returns to the block 505. Otherwise, the process 500 ends.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
while a host vehicle is within an area, identify a target vehicle based on detecting the target vehicle within the area;
upon determining a component output, provide, to the target vehicle, first instructions specifying the component output and a target vehicle component;
synchronize a host clock for the host vehicle with a clock maintained by a remote server computer;
then provide, to the target vehicle, second instructions specifying to initiate, at a target time, actuation of the target vehicle component to provide the component output; and
then actuate, at a host time, a host vehicle component to provide the component output.

2. The system of claim 1, wherein the instructions further include instructions to determine an availability of the target vehicle to provide the component output based on receiving, from a second computer in the target vehicle, a message specifying the availability.

3. The system of claim 1, further comprising a second computer in the target vehicle, the second computer including a second processor and a second memory storing instructions executable by the second processor such that the second computer is programmed to, upon receiving the first instructions, synchronize a target clock for the target vehicle with the clock maintained by the remote server.

4. The system of claim 3, wherein the second computer is further programmed to actuate, at the target time, the target vehicle component to provide the component output.

5. The system of claim 1, wherein the component output is one of a light output or a sound output.

6. The system of claim 1, wherein the first instructions further specify a parameter of the component output, the parameter including at least one of a volume, a duration, or a light intensity.

7. The system of claim 1, wherein the instructions further include instructions to determine poses for the host vehicle and the target vehicle within the area based on the component output.

8. The system of claim 7, wherein the instructions further include instructions to provide the pose for the target vehicle to the target vehicle.

9. The system of claim 8, further comprising a second computer in the target vehicle, the second computer including a second processor and a second memory storing instructions executable by the second processor such that the second computer is programmed to operate the target vehicle to the pose for the target vehicle.

10. The system of claim 7, wherein the instructions further include instructions to operate the host vehicle to the pose for the host vehicle.

11. The system of claim 1, wherein the instructions further include instructions to determine the component output based on receiving a user input.

12. The system of claim 1, wherein the component output includes a target component output and a host component output different from the target component output, and wherein the instructions include instructions to provide the host component output.

13. The system of claim 12, further comprising a second computer in the target vehicle, the second computer including a second processor and a second memory storing instructions executable by the second processor such that the second computer is programmed to provide the target component output.

14. The system of claim 1, wherein the host time and the target time are a same time.

15. The system of claim 1, wherein the host time and the target time are a different time.

16. A method, comprising:
while a host vehicle is within an area, identifying a target vehicle based on detecting the target vehicle within the area;
upon determining a component output, providing, to the target vehicle, first instructions specifying the component output and a target vehicle component;
synchronizing a host clock for the host vehicle with a clock maintained by a remote server computer;
then providing, to the target vehicle, second instructions specifying to initiate, at a target time, actuation of the target vehicle component to provide the component output; and
then actuating, at a host time, a host vehicle component to provide the component output.

17. The method of claim 16, wherein the component output is one of a light output or a sound output.

18. The method of claim 16, further comprising determining the component output based on receiving a user input.

19. The method of claim 16, wherein the host time and the target time are a same time.

20. The method of claim 16, wherein the host time and the target time are a different time.
